(19) United States
(12) Patent Application Publication
(10) Pub. No.: US 2020/0321744 A1
(43) Pub. Date: Oct. 8, 2020

(54) SYSTEM AND METHOD FOR MONITORING HEALTH OF A LASER

(71) Applicant: Optec Laser Systems, LLC, San Diego, CA (US)

(72) Inventor: John Roy, San Diego, CA (US)

(21) Appl. No.: 16/781,926

(22) Filed: Feb. 4, 2020

Related U.S. Application Data
(60) Provisional application No. 62/800,977, filed on Feb. 4, 2019.

(51) Int. Cl. H01S 3/00; H01S 3/03; H01S 3/02; G08B 21/18

(52) U.S. Cl. CPC H01S 3/0014; G08B 21/182; H01S 3/025; H01S 3/03

(57) ABSTRACT

Disclosed are apparatuses, systems, methods, and computer program products for monitoring the health of a laser such as solid-state laser or a gas laser. For example, the laser may be included in a laser machining system. The laser may be controlled by controller and an interface to communicate with the laser including status information and commands. The laser health monitor passively receives the status information from the laser and the commands to the laser without disturbing the communication between the laser and the laser controller. The laser health monitor generates alerts when one or more rules applied to the laser status information indicate a condition such as stale gas, low energy production, incorrect voltages, as well as other conditions. The alerts may be sent via email or SMS message or another communication mechanism to a recipient.

### PRIORITY CLAIM AND RELATED PATENT APPLICATION

This patent document claims the priority and benefits of U.S. Provisional Application No. 62/800,977 entitled “A SYSTEM AND METHOD FOR MONITORING THE HEALTH OF A LASER” and filed on Feb. 4, 2019 by Applicant Optec Laser Systems, LLC, the disclosure of which is incorporated by reference as part of the disclosure of this patent document.

### BACKGROUND

Lasers are used throughout industry, for research, and in medicine. Some examples of applications for lasers include laser cutting, welding, laser machining and drilling, semiconductor photolithography, LASIK eye surgery, as well as other applications. Many types of lasers must be maintained in those applications. For example, the gas media in a gas laser may become stale and thus may need refill of the gas media or in some cases a gas laser may have a gas leak. New techniques are needed to ensure that gas or other lasers are performing properly and to determine when service is needed.

### SUMMARY

This patent document provides, among others, a technology for monitoring the heath of laser for maintaining the normal operation of the laser and generating an alert when the laser is not in the normal operation. In one aspect, the disclosed technology can be implemented to provide a system for monitoring the health of a laser which includes a laser; a laser controller coupled to communicate with and to control the laser; and a laser health monitor coupled to monitor a communication between the laser and the laser controller. The monitoring comprises receiving a laser status passed from the laser to the laser controller, and the laser health monitor determines from the laser status whether the laser is operating outside one or more predefined operating ranges.

In another aspect, the disclosed technology can be implemented to provide a method of determining a laser health which includes monitoring, by a laser health monitor, a communication between a laser and a laser controller that controls the laser, wherein the monitoring comprises receiving a laser status passed from the laser to the laser controller; and determining, by the laser health monitor, from the laser status, whether the laser is operating outside one or more predefined operating ranges. In this method, when the laser is operating outside at least one of the one or more predefined operating ranges, the laser health monitor sends an alert message; and when the laser is operating inside the predefined operating ranges, the monitor does not send the alert message. In implementations, an alert message may be sent to a recipient via one or more of a local network, an SMS message and/or email application, or a cloud notification service.

The above and other aspects and implementations of the disclosed technology are described in greater detail in the drawings, the description and the claims.

### BRIEF DESCRIPTION OF THE DRAWINGS

FIGS. 1A-1B depict example block diagrams of laser health monitoring systems, in accordance with some example embodiments;

FIG. 2 depicts an example of a graphical user interface (GUI), in accordance with some example embodiments;

FIG. 3 depicts an example of a process, in accordance with some example embodiments; and

FIG. 4 depicts an example of an apparatus, in accordance with some example embodiments.

Where possible, like reference numerals refer to the same or similar features.

### DETAILED DESCRIPTION

Disclosed are apparatuses, systems, methods, and computer program products for monitoring the health of a laser such as a gas laser or a solid-state laser. For example, the health of a laser in a laser machining system, a laser welding system, a laser drilling system, or other laser systems may be monitored. The laser may be controlled by a controller that includes executable code and an interface to communicate with the laser. For example, control information including status information and commands may be exchanged between the laser and controller via the interface. In some example embodiments, the laser health monitor passively receives the status information from the laser and the commands to the laser without disturbing the communication between the laser and the laser controller. The status information may include laser voltages, gas pressures, and the laser energy or power produced. Based on the status information (also referred to herein as a laser state) and rules with user selectable thresholds and values, alerts may be generated. For example, when the rules applied to the status information indicate conditions such as stale gas, low energy production, incorrect voltages, as well as other conditions, one or more alerts may be generated. For many lasers, optical alignment is needed to produce a desired power output. If the power output is low, and the alignment is correct, a low power output may be due to stale gas, a drop in voltage or a degradation of optics in the laser or the laser beam delivery components. In some example embodiments, executable instructions performing at least a portion of the laser controller may execute on a processor included with the laser health monitor, and in other embodiments, executable laser controller instructions may execute on another processor. The conditions and the alerts may be displayed and changed via a graphical user interface (GUI) or via data stored in a configuration file. The laser health monitor may generate an email or a short message service (SMS) message to be sent to a user alerting the user of the occurrence of the condition as determined by an associated rule. In some example embodiments, a laser status report may be generated periodically and sent as an alert. Detectors and devices that may be included in the laser health monitor include one or more of a laser power meter, a laser beam profiler, a video camera, or a hazardous gas detector.

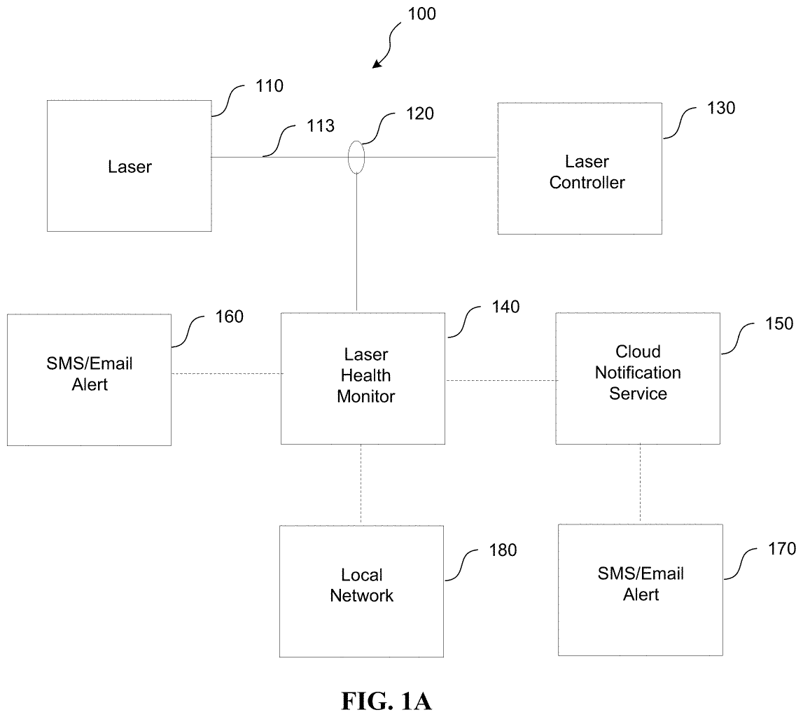

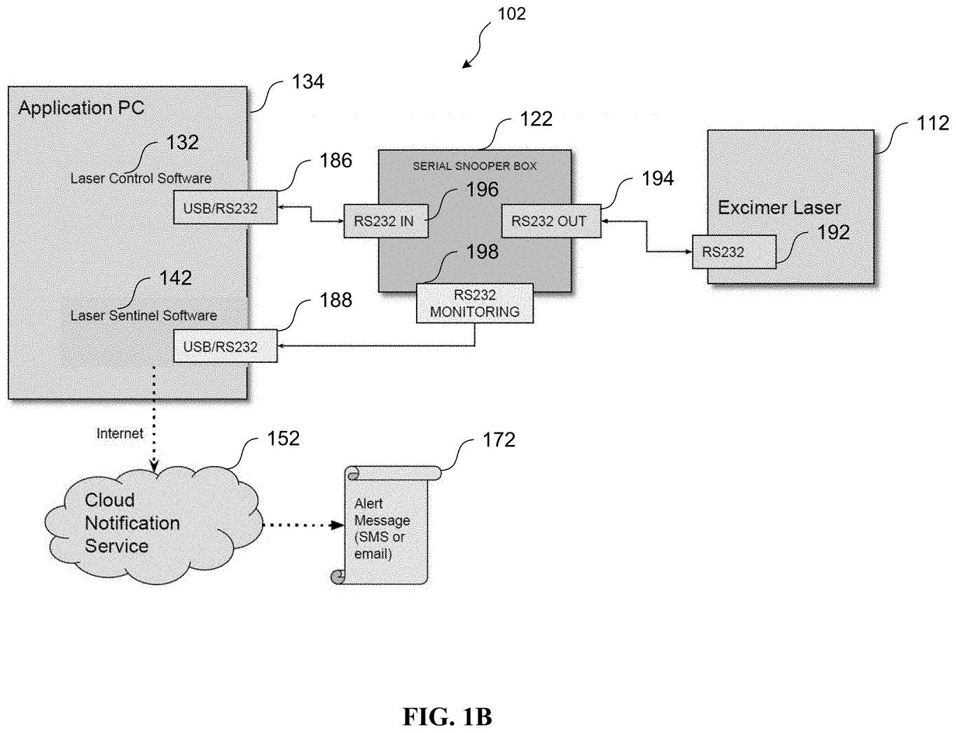

FIG. 1A depicts an example block diagram of a laser health monitoring system 100, in accordance with some example embodiments. System 100 includes laser 110 and laser controller 130 which communicate via interface 113, and laser health monitor 140. Laser health monitor 140 may receive laser status information and commands via listener 120 which eavesdrops on the status passed from the laser 110 to laser controller 130 and eavesdrops on the commands passed form the laser controller 130 to the laser 110. The laser health monitor 140 may generate one or more alerts or notifications to be sent to a recipient via one or more of a local network 180, an SMS message and/or email 160, and/or a cloud notification service 150 that may cause an SMS message or email alert 170 to be sent.

Laser 110 may be a laser in various configurations, such as a gas laser including an excimer laser, a solid-state laser including optically pumped lasers having doped crystals or other solid state materials as the laser gain media, various lasers using one or more semiconductor lasers as the pumping source, or other types of lasers. Laser 110 may be a high-power laser used in various applications such as laser cutting or machining systems or in medical surgical processes. Laser 110 is controlled by laser controller 130 which may send a command to turn the laser on or off or another command, and may receive status information from the laser such as the temperature of the laser, laser output power, a status of a shutter, the serial number of the laser, and/or a date/time stamp for when the laser gas was last replaced, as well as other information.

Laser 110 and laser controller 130 communicate via interface 113. Interface 113 may be any type of wired, wireless, or optical interface. Interface 113 may include a standard wired interface such as RS-232, RS-422, Ethernet or another standard wired interface, or may be a wireless interface such as WiFi or Bluetooth, or any other standard wireless interface, or may be a proprietary wired or wireless interface.

Listener 120 eavesdrops on the communications between laser 110 and laser controller 130 via interface 113. For example, listener 120 may receive or detect commands sent from laser controller 130 to laser 110, and listener 120 may receive or detect status information sent from laser 110 to laser controller 130. Listener 120 may passively receive the information. That is, listener 120 may receive the information without altering any aspect of the communications between the laser 110 and laser controller 130. For example, an RS-232 “snooping” box may passively receive the status and command information. In another example, an Ethernet “packet sniffer” may passively receive the status and command information.

In some example embodiments, listener 120 may break the communications between laser controller 130 and laser 110. Listener 120 receives the commands from laser controller 130 and receives the status information from laser 110 and retransmits the commands to the laser 110 and retransmits the status information to the laser controller 130.

In some example embodiments, interface 113 may be a software interface rather than a hardware interface such as RS-232 or Ethernet. In this case, listener 120 may be implemented in software to receive the commands and laser status information.

Laser health monitor 140 receives from listener 120 the commands sent from the laser controller 130 to the laser 110 and receives the status information sent from the laser 110 to the laser controller 130. In some example embodiments, laser health monitor 140 includes a computer such as a single board computer (SBC) with memory that stores executable instructions to perform at least part of the laser health monitor. For example, a Raspberry Pi single board computer, or another single board computer may be used at 140. In some example embodiments, instead of using a separate SBC, the laser health monitor 140 may include executable instructions that execute on a computer that also performs other functions such as performing the laser controller 130. For example, a personal computer, application personal computer, or server may run an application that performs the laser control and another application that performs at least a portion of the laser health monitoring functions.

The laser health monitor 140 may generate one or more alerts or notifications to be sent to a recipient via one or more of a local network 180, an SMS message and/or email 160 application, or a cloud notification service 150 that may cause an SMS message or email alert 170 to be sent. For example, laser health monitor 140 may generate an alert based on stale gas in the laser. In this example, the laser health monitor 140 may compare a time difference between a date/time stamp recorded from the last gas replacement/refill and a current date/time, compare the difference to a threshold value that when exceeded causes a stale gas alert to be generated by the laser health monitor. The alert may be sent to an SMS/email alert device or application 160 to send the alert to a recipient such as an entity responsible for maintenance of the laser 110.

In another example, laser health monitor 140 may send the alert to a cloud notification service 150 such as Amazon Web Services (AWS). The cloud service then sends the email/SMS message 170 to a recipient. In some example embodiments, using a cloud service simplifies the implementation of laser health monitor 140 by relieving the laser health monitor 140 from networking functions needed to send the SMS/email alert directly.

In another example, laser health monitor 140 may send the alert to a recipient via a local network 180. For example, laser health monitor 140 may connect via a wired or wireless interface to a local network to which the recipient is also connected. Laser health monitor 140 may generate an alert and send the alert via the local network 140 to the recipient. In each of the foregoing examples, communications and/or messages such as alerts may be encrypted.

FIG. 1B depicts another example block diagram of a laser health monitoring system 102, in accordance with some example embodiments. System 102 includes excimer laser 112, serial snooper box 122, and computer 134. Computer 134 executes laser control software 132 and laser sentinel software 142 (also referred to as, laser health monitor). Although FIG. 1B shows both the laser control software 132 and laser sentinel software 142 running on the same computer 134, they may run on different computers as described above. For example, the laser sentinel software 142 may run on an SBC and the laser control software 132 may run on a different computer. Serial snooper box 122 (or listener 122) is inserted in the RS-232 communications path between the excimer laser 112 and laser control software 132. The serial snooper box passively, or non-passively, receives the commands and status information passed between the excimer laser 112 and laser control software 132 and forwards the received commands and information via RS-232 interface 198 to the laser sentinel software 142 via USB/RS-232 interface 188. For example, the serial snooper box 122 passively, or non-passively, receives commands from computer 134 via USB/RS-232 interface 186 and passes the commands to RS-232 interfaces 198 and 188 to laser sentinel software 142 and to the excimer laser 112 via RS-232 interfaces 194 and 192. Also, the serial snooper box 122 passively, or non-passively, receives status information from excimer laser 112 via RS-232 interfaces 192 and 194 and passes the status information to RS-232 interfaces 198 and 188 to laser sentinel software 142 and to RS-232 interfaces 196 and 186 to laser control software 132. The laser sentinel software 142 may generate one or more alerts or notifications to be sent to a recipient via one or more of a local network 180 (not shown), an SMS message and/or email 160 (not shown), and/or a cloud notification service 152 that may cause an SMS message or email alert 172 to be sent.

The laser sentinel software 142 may run in the background to monitor communications, collect data/information and send out notifications/alerts. It can run without any user intervention and can be set to execute automatically upon startup of the computer. The laser sentinel software 142 can accept commands over a network socket connection. A network socket may or may not include an actual network. For example, the network may be internal to the computer 134 and may be used for programs to communicate with one another. The laser sentinel software 142 may process sets of rules which define what events (e.g. constitute something that the user needs to be notified of.). The rules may be defined in a configuration file and thus are changeable in laser sentinel software 142. For example, a rule could be made that gets triggered when the laser shot count is a predetermined number that results in an alert being generated. The laser sentinel software 142 monitors the laser, logs data, checks the laser's operational state, and generates notifications when a rule is triggered by an event. Notifications may be generated and/or sent by sending a message to the cloud service (e.g., AWS). The cloud service may then send the email or text.

A GUI program may be a front-end for the laser sentinel software 142 and may send commands (via the socket connection) to the laser sentinel software 142 to check status and get/set configuration settings. The GUI may display conditions and settings on the screen and react to user input. The GUI may run when needed or all the time. For example, the GUI may need to run when a user or operator wants to change a setting. The GUI can be cross-compiled to run on Windows, iOS, Android, or macOS, or any other operating system. The GUI may be configured for use by a cellular phone or smartphone where the phone and the computer 134 are on the same network or when a relay server is used. The relay server may act like a gateway between a network accessible by computer 134 and the phone's network. In some example embodiments, the relay server may be a process running in the cloud.

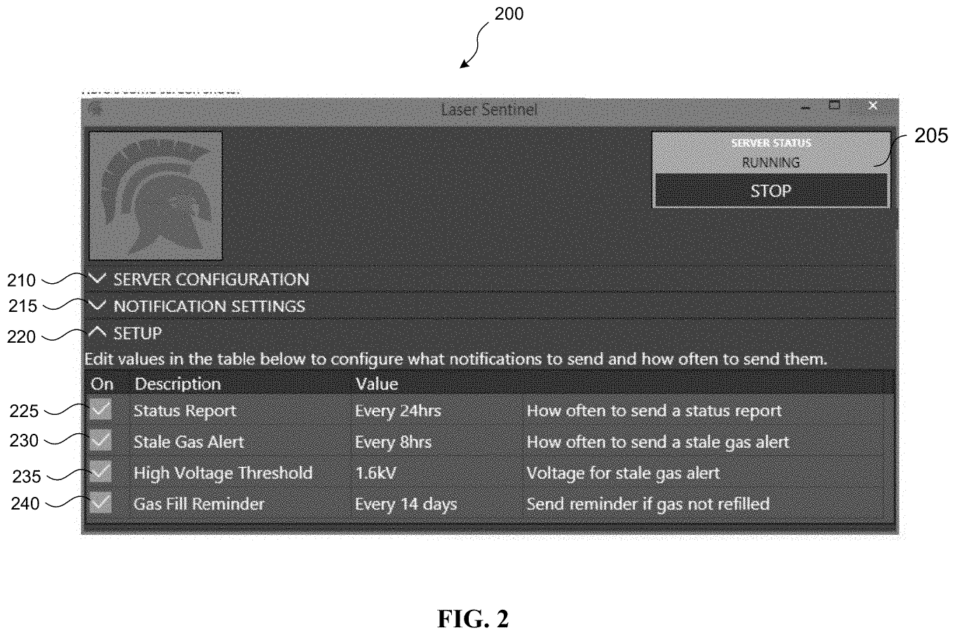

FIG. 2 depicts an example of a GUI 200, in accordance with some example embodiments. GUI 200 may be generated by executable code running on a laser health monitor 140, or laser sentinel software 142, or on another computer. The GUI may display status information about the laser and commands related to the laser health monitor and provide an interface for values used in rules and the rules themselves to be changed.

At 205, an example of a status of the laser health monitor is shown as “running” with a clickable command to “stop” the laser health monitor. As with other commands and selections described below, by clicking with a pointing device on an area near where text for the command is shown, the command or selection may be toggled. The following commands and selections can also be executed via a script file containing the commands and selections. By clicking on “stop” at 205, the laser health monitor may be stopped.

At 210 is a tab for laser health monitor configuration (also referred to as server configuration). By clicking on the tab, a list of configuration items is shown. For example, a user may select configuration items and enter information and selections into the appropriate locations.

At 215, is a tab for notification settings. By clicking on the tab, a selectable list of notification settings is shown. Alert settings may include a selection of which communications mechanism(s) alert(s) are sent and one or more email addresses and/or SMS message destinations for the alert(s).

At 220, is a setup tab. By clicking on the tab, a selectable list of settings is shown. For example, alert settings including a selectable list of rules and associated values or threshold values for generating an alert. A user may be able to enter of change values in the GUI for the settings.

Shown at 225 is a clickable or selectable box to enable sending a “status report,” a value of “every 24 hours” and a note describing the setting of “How often to send a status report.” Values other than “every 24 hours” may be selectable by clicking on the value and choosing a different value from a list or by entering a different value via an input device such as a keyboard. The value “every 24 hours” may cause a status report with laser operation and health parameters to be generated and sent via a communications mechanism selected in the “notification settings” tab 215.

Shown at 230 is a clickable or selectable box to enable sending a “stale gas alert,” a value of “every 8 hours” and a note describing the setting of “How often to send a stale gas alert.” Values other than “every 8 hours” may be selectable by clicking on the value and choosing a different value from a list or by entering a different value via an input device such as a keyboard. The value “every 8 hours” may cause an alert to be generated and sent via a communications mechanism selected in the “notification settings” tab 215. The “stale gas alert” may be triggered by the gas in the laser having not been refilled during a period of time since it was last refilled. For example, the “stale gas alert” may be generated if the gas has not been refilling in 14 days (see also 240 below). In this example, once the gas has not been refilled for 14 days, the “stale gas alert” sends an alert “every 8 hours” as detailed above.

Shown at 235 is a clickable or selectable box to enable sending a “high voltage” alert and a value of “1.6 kV” (kilovolts) and a note describing the setting of “Voltage for stale gas alert.” Values other than “1.6 kV” may be selectable by clicking on the value and choosing a different value from a list or by entering a different value via an input device such as a keyboard. The value “1.6 kV” may cause an alert to be generated and sent via a communications mechanism selected in the “notification settings” tab 215. For example, when the laser voltage is 1.6 kilovolts or higher, an alert may be generated.

Shown at 240 is a clickable or selectable box to enable sending a “gas fill reminder” alert and a value of “Every 14 days” and a note describing the setting of “Send a reminder if gas not refilled.” Values other than “Every 14 days” may be selectable by clicking on the value and choosing a different value from a list or by entering a different value via an input device such as a keyboard. The value “every 14 days” may cause an alert to be generated and sent via a communications mechanism selected in the “notification settings” tab 215. For example, when the period of time since the laser gas was last refilled is 14 days or longer, an alert may be generated. In this example, a single alert may be generated, or alerts may be generated periodically such as a “gas fill reminder” alert every 8 hours or another time period between alerts.

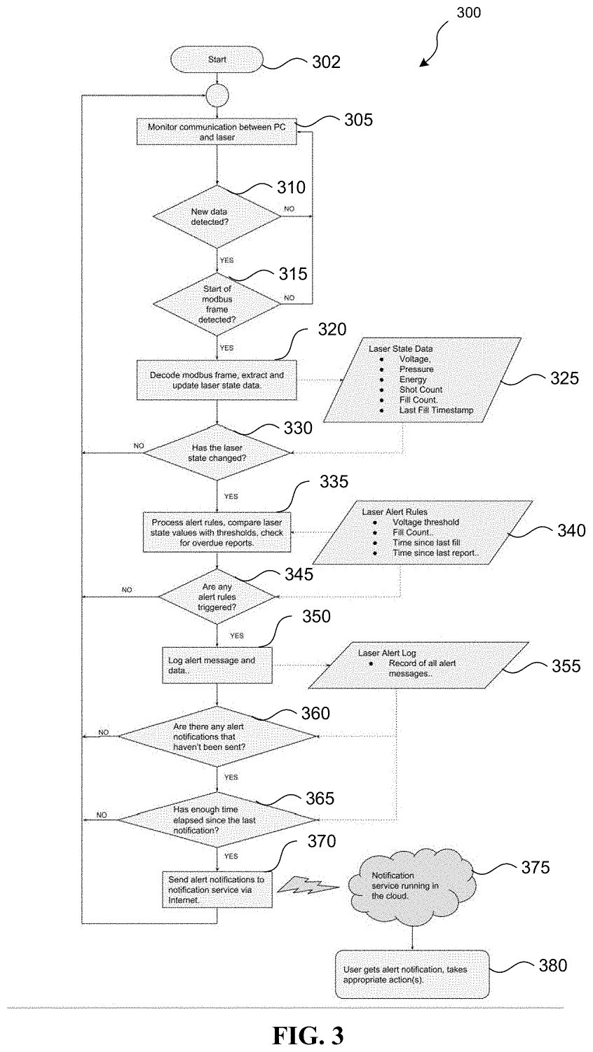

FIG. 3 depicts a process 300, in accordance with some example embodiments. The process may be performed by a laser health monitor such as laser health monitor 140 or 142. The process 300 may be performed in electronic hardware, by a programmable gate array (e.g., a field-programmable gate array (FPGA)), in software or firmware, or by a combination of these. As used below in the description of FIG. 3, laser 110 is used but also applies to excimer laser 112, laser controller 130 is used but also applies to laser control software 132, listener 120 is used but also applies to serial snooper box 122, and laser health monitor 140 is used but also applies to laser sentinel software 142.

The process starts at 302 and as the result of multiple later decisions returns to 302. At 305, the process includes monitoring communications between laser 110 and laser controller 130. Listener 120 may be used to monitor the communications. At 310, the process determines if new data has been passed between the laser and laser controller. If not, the process returns to 302. If new data has been detected, the process determines if a start of a data communication frame has occurred. The data communication frame may be based on a suitable data communication protocol from various data communication protocols including, for example, the Modbus protocol originally developed by Modicon/Schneider Electric. If a start of a data communication frame has not occurred, the process returns to 302. If a modbus frame has been detected, then the laser state information is extracted and updates the previous state information. Laser state information includes one or more of laser voltage, gas pressure, laser energy per pulse, a pulse shot count, a fill count, and a last gas fill timestamp. At 330, the process determines if the laser state has changed by comparing the extracted state information to the previous laser state information. If the laser state has not changed, the process returns to 302. If the state has changed, then the alert rules are processed to compare the laser state values to rule values and thresholds, and a check is made for overdue reports. Alert rules include one or more of a threshold laser voltage, a fill count, the time since the last fill, and the time since the last report. At 345, the process determines if any of the rules have been triggered. If not, then the process returns to 302. If one or more rules have been triggered, then the generated alerts are stored in an alert log. At 360, the process determines if there are any alert messages that have not yet been sent. If there are no alert messages that have not been sent, then the process returns to 302. If there are alert messages that have not been sent, then the process determines if a threshold amount of time has passed since one or more last alerts have been sent. If the threshold time has not elapsed, then the process returns to 302. If the threshold time has elapsed, then alerts are sent. The alerts may be sent via an SMS message, am email, or other type of message. The alerts may be sent directly via SMS or email or through a cloud service or local network. For example, alerts may be sent at 375 via a service in the cloud such as AWS detailed above. At 380, a recipient/user receives the messages and takes appropriate action. Although may process steps are detailed above, some of the process steps may be omitted in some example embodiments. In some embodiments, some process steps not detailed above but are described in this document may be included.

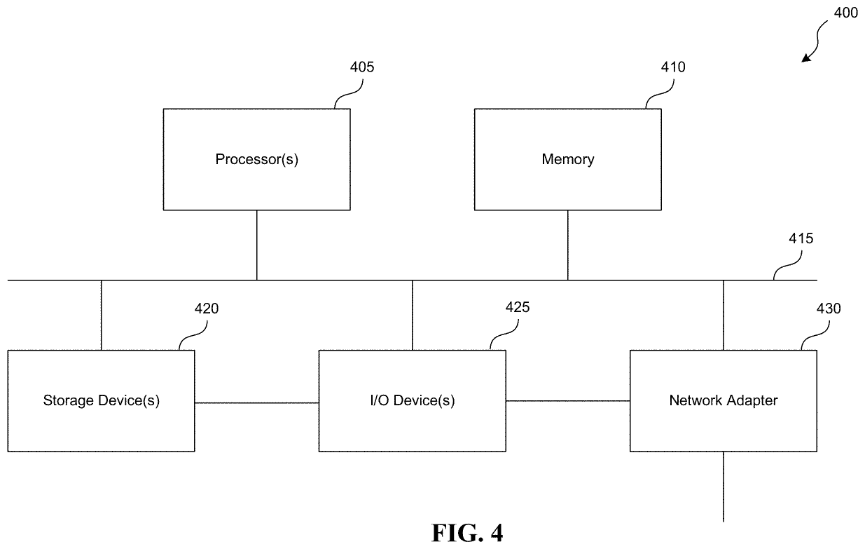

The processes and functions described above and in FIGS. 1A, 1B, 2, and 3 may be performed by an apparatus that may include one or more processors. FIG. 4 is a block diagram of an example of a computing system, consistent with various embodiments. The computing system 400 may include one or more central processing units (“processors”) 405, memory 410, input/output devices 425 (e.g., keyboard and pointing devices, display devices), storage devices 420 (e.g., disk drives), and network adapters 430 (e.g., network interfaces) that are connected to an interconnect 415. The interconnect 415 is illustrated as an abstraction that represents any one or more separate physical buses, point to point connections, or both connected by appropriate bridges, adapters, or controllers. The interconnect 415, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 410 and storage devices 420 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 410 can be implemented as software and/or firmware to program the processor(s) 405 to carry out actions described above. In some embodiments, such software or firmware may be initially provided to the processing system 400 by downloading it from a remote system through the computing system 400 (e.g., via network adapter 430).

The technology introduced herein can be implemented by, for example, programmable circuitry (e.g., one or more microprocessors) programmed with software and/or firmware, in special-purpose hardwired (non-programmable) circuitry, or in a combination of such forms. Special-purpose hardwired circuitry may be in the form of, for example, one or more ASICs, PLDs, FPGAs, etc.

While this patent document contains many specifics, these should not be construed as limitations on the scope of any disclosed methods or of what may be claimed, but rather as descriptions of features that may be specific to particular embodiments of particular disclosed methods. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Only a few implementations and examples are described and other implementations, enhancements and variations can be made based on what is described and illustrated in this patent document.

What is claimed is:

1. A method of determining a laser health condition, comprising:
monitoring, by a laser health monitor, a communication between a laser and a laser controller that controls the laser, wherein the monitoring comprises receiving a laser status passed from the laser to the laser controller; and
determining, by the laser health monitor, from the laser status, whether the laser is operating outside one or more predefined operating ranges, wherein when the laser is operating outside at least one of the one or more predefined operating ranges, the laser health monitor sends an alert message, and wherein when the laser is operating inside the predefined operating ranges, the monitor does not send the alert message.

2. The method of claim 1, further comprising:
receiving a laser command passed from the laser controller to the laser.

3. The method of claim 1, wherein the monitoring includes receiving without altering the communication and without retransmitting the communication to the laser or the laser controller.

4. The method of claim 1, wherein the monitoring includes receiving the communication and retransmitting the communication to the laser or the laser controller.

5. The method of claim 1, wherein the laser status includes one or more of:
a laser voltage;
a gas pressure;
a laser pulse energy;
a laser shot count;
a laser fill count; or
a last gas fill timestamp.

6. The method of claim 1, wherein the alert message is sent as an SMS message to a recipient.

7. The method of claim 1, wherein the alert message is sent as an email message to a recipient.

8. The method of claim 1, wherein the sending the alert message includes sending the alert message to a cloud service and the cloud service sends the alert to a recipient.

9. The method of claim 1, wherein the monitored communication is a wired interface.

10. The method of claim 9, wherein the wired interface is RS-232.

11. The method of determining a laser health of claim 9, wherein the wired interface is RS-422.

12. The method of claim 9, wherein the wired interface is Ethernet.

13. The method of claim 1, wherein the monitored communication is wireless.

14. A system for monitoring the health of a laser, comprising:
a laser;
a laser controller coupled to communicate with and to control the laser; and
a laser health monitor coupled to monitor a communication between the laser and the laser controller, wherein the monitoring comprises receiving a laser status passed from the laser to the laser controller, and wherein the laser health monitor determines from the laser status whether the laser is operating outside one or more predefined operating ranges.

15. The system of claim 14, wherein when the laser is operating outside at least one of the one or more predefined operating ranges, the laser health monitor sends an alert message, and wherein when the laser is operating inside the predefined operating ranges, the monitor does not send the alert message.

16. The system of claim 14, wherein the monitoring includes receiving without altering the communication and without retransmitting the communication to the laser or the laser controller.

17. The system of claim 14, wherein the monitoring includes receiving the communication and retransmitting the communication to the laser or the laser controller.

18. The system of claim 14, wherein the laser status includes one or more of:
a laser voltage;
a gas pressure;
a laser pulse energy;
a laser shot count;
a laser fill count; or
a last gas fill timestamp.

19. The system of claim 14, wherein the laser health monitor and the laser controller operate using the same computer.

20. The system of claim 14, wherein the laser health monitor operates using a single board computer (SBC) and the laser controller operates using the different computer.
